(19) United States
(12) Patent Application Publication
(10) Pub. No.: US 2020/0084691 A1
(43) Pub. Date: Mar. 12, 2020

(54) User Equipment and Method in a Wireless Communications Network

(71) Applicant: TELEFONAKTIEBOLAGET LM ERICSSON (PUBL), Stockholm (SE)

(72) Inventors: Pontus WALLENTIN, Linköping (SE); Jens BERGQVIST, Linköping (SE); Christofer LINDHEIMER, Linköping (SE)

(73) Assignee: Telefonaktiebolaget LM Ericsson (publ), Stockholm (SE)

(21) Appl. No.: 16/060,139

(22) PCT Filed: Apr. 23, 2018
(86) PCT No.: PCT/SE2018/050412

§ 371 Date: Jun. 7, 2018

Related U.S. Application Data
(60) Provisional application No. 62/520,583, filed on Jun. 16, 2017.

(51) Int. Cl. H04W 48/02; H04W 76/27

(52) U.S. Cl. CPC H04W 48/02; H04W 48/16; H04W 76/27

(57) ABSTRACT

A method performed by a User Equipment (UE) for controlling a data transmission over a bearer in a wireless communications network is provided. When the bearer is established, the UE determines (1102), an access category for the data to be transmitted over the bearer. The UE associates (1104) the determined access category with the bearer. When the data is to be transmitted over the bearer, the UE performs (1106) barring check of the access category associated with the bearer. When the access category associated with the bearer is barred, the UE decides (1108) to not transmit the data, and when the access category associated with the bearer is not barred, the UE decides (1110) to initiate a procedure to transmit the data over the bearer.

### TECHNICAL FIELD

Embodiments herein relate to a User Equipment (UE), and methods therein. In particular, they relate to controlling a data transmission over a bearer in a wireless communications network.

### BACKGROUND

In a typical wireless communication network, wireless devices, also known as wireless communication devices, mobile stations, stations (STA) and/or User Equipments (UE), communicate via a Local Area Network such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the 5 transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

Access Control

When performing access to a wireless communication system, a UE must signal to the network that it wants to acquire communication opportunities. There are many schemes for how this can be done. For example, a UE may utilize air-interface resources (e.g., times, frequencies) to send a short message that would indicate to the network that a UE wants to communicate. Further details about a certain communication need can then occur in subsequent communication.

The event which triggers a UE to perform a request to access a wireless communication system may for example be a need for an application, such as a software module in the UE, to transmit uplink user data, and/or receive downlink user data. Or, a need to exchange signaling messages with a network node, or alternatively, a combination of both.

Consider a simplified wireless network 10 illustrated in FIG. 1, with a UE 12, which communicates with an access node 14, which in turn is connected to a network node 16.

For wireless communication systems pursuant to 3GPP E-UTRAN/LTE standard specifications, the access node 14 corresponds typically to an Evolved NodeB (eNB) and the network node 16 corresponds typically to either a Mobility Management Entity (MME) and/or a Serving Gateway (SGW).

In 3GPP LTE, a request for communication is performed by initiating a random access procedure followed by an RRC Connection Establishment procedure. Please see FIG. 2 depicting a Random access and Radio Resource Control (RRC) connection establishment in 3GPP LTE

This sequence starts with a transmission of a Random Access Preamble 201, also known as “msg1”, on specifically allocated channels or resources. This random access preamble is, when received by a base station or eNB, followed by a random access response 202, also known as “msg2” that includes an allocation of resources for continued signaling, in this case the RRC Connection Request 203, also known as “msg3” which is the first message in the RRC Connection Establishment procedure.

As is easily realized, an access attempt will cost air interface resources. The initial message 201, Preamble as well as resources for further signalling 202-205 will add to the wireless network load, simply to configure and setup communication resources for subsequent data transfer. It should be noted that even further communication is needed with network entities before any communication can take place, these are omitted from FIG. 2.

Under certain circumstances, it is desirable to prevent UE's from making these access attempts. For example, in case of an overload situation like radio resource congestion or shortage of processing capabilities, a network may wish to reduce overload by denying access to a cell. The network may also need to prioritize between specific users and/or services during overload situations. For example, to give priority to emergency calls compared to ordinary calls.

To this end, the network may employ what is in 3GPP referred to as access control. Access Class Barring (ACB) is an example of one such control. In short, access barring is about preventing or making it less likely that a UE will attempt to send an access request (e.g., to initiate the sequence above by sending a preamble, 201). In this way, the total load in the system can be controlled. The network may for example divide UE's or different reasons for why a UE want access into different classes, or categories and dependent on this, the network can differentiate and make it less likely that, e.g., certain UE's and/or certain events trigger access requests. For example, a given UE may belong to a certain access class and the network may communicate, via broadcasted system information, that certain classes at certain instances are barred, i.e., not allowed to make access, or allowed to make access with a lower probability if not barred altogether. When a UE receives this broadcasted system information, if it belongs to a barred access class, it may result in that a UE will not send an access request. There are multiple variants of access barring mechanisms specified for LTE.

1. Access Class Barring as per 3GPP Rel-8: In this mechanism, it is possible to bar all access requests from a UE. Normal UEs in Access Class (AC) range 0-9 are barred with a probability factor, also referred to as barring factor and a timer, also referred to as barring duration, whereas specific classes can be controlled separately. Beside the normal classes 0-9, additional classes have been specified to control the access to other type of users, e.g. emergency services, public utilities, security services, etc.

2. Service Specific Access Control (SSAC): The SSAC mechanism allows a network to prohibit Multi-Media Telephony (MMTel)—voice and MMTel-video accesses from a UE. The network broadcasts barring parameters (parameters similar to ACB) and a barring algorithm that is similar to ACB (barring factor and random timer). An actual decision if access is allowed is done in the IP Multi-Media Subsystem (IMS) layer of a UE.

3. Access control for Circuit-Switched FallBack (CSFB): The CSFB mechanism allows a network to prohibit CSFB users. A barring algorithm used in this case is similar to ACB.

4. Extended Access Barring (EAB): The EAB mechanism allows a network to prohibit low priority UEs. Barring is based on a bitmap in which each access class (AC 0-9) can be either barred or allowed.

5. Access class barring bypass: The ACB mechanism allows omitting access class barring for IMS voice and video users.

6. Application specific Congestion control for Data Communication (ACDC) barring: ACDC allows barring of traffic from/to certain application. In this solution, applications are categorized based on global application identification (ID) (in Android or iOS). The network broadcasts barring parameters (barring factor and timer) for each category.)

An ongoing evolution of these different access control mechanisms, in particular for 5th generation cellular standards according to 3GPP, is to gather them into one single mechanism that can be configurable and adaptable to various network operator preferences. This is here from referred to as Unified Access Control (UAC). With unified access control, there is a single set of access categories (similar to classes). An access category may be used as a differentiator when prioritizing among access requests. At least some access categories should be possible to configure, such that, for example, access category X is used for certain pre-determined accesses. Access category X can relate to for example which core network a certain UE is aiming to access, what service that triggers the access, e.g., SMS, MMTel or other services, Other aspects can also be included when determining access category. As an example an access category (UBMCat) determination can be dependent on a number of aspects, such as;

UBMCat=f( . . . , AccessClass=nn, CN=NG, EstablishmentCause=mo, Service=ServiceID, DeviceType=MTC, call Priority=Low, ApplicationID=yy . . . , Slice ID=NN, PLMN ID=pp, . . . )

Where Access class may denote the old access class as described above, CN is a core network type, Establishment cause is one of several establishment causes as described further below, Service=Service ID, Device Type can be for example a Machine Type Communication device and a general priority for application ID yy may be considered low when accessing slice ID NN on PLMN I pp.

All or any subset of these as well as other aspects may be considered when determining access category. This provides a flexible way to make a future-proof framework for access category and access barring. One proposed procedure for unified access control is described below, in connection to FIG. 3.

Before an access is attempted by a UE 12, it needs to associate an event, such as for example a trigger from higher layers in the UE to send a signaling message, to an access category of the [1. . m] access categories.

To do this, the UE may be provided with instructions or rules from the network. FIG. 3 illustrates a signaling diagram for one exemplary procedure.

In a first action 302, a network node provides rules for which access category to use, based on considerations that relate to higher layers. In FIG. 3, this information is illustrated as originating from the network node 16 but may very well also originate from other network nodes and be transmitted to the UE via network node 16. If the network includes a higher-level controller or policy functionality it may originate from another node hosting such controller or policy functionality. The higher layer rules may be signaled to the UE via Non-Access-Stratum (NAS) signaling, or it may be signaled using other protocols, For example, the UE 12 may include an entity that can be configured with and host access category rules signaled using an OMA-DM device management protocol.

Included in the rules from the network node 16 may be information related to for example, how a UE should select access category if the access is triggered by a certain service. Examples of such services can be for example an emergency service or an MMTel Service. Further, the rules can include information related to how a UE should select access category if an access is triggered by a certain application, such as, e.g., a certain game or a certain social media application. Rules can also include information related to access to various slices. For example, a small device-UE 12, may want to access, e.g., an loT-optimized slice. Further, it is not uncommon that radio networks are shared between different operators or that one and the same operator is using different Public Land Mobile Network (PLMN) codes. There may be different rules for selecting access category dependent on if access is to occur for different PLMN's.

It should be noted that action 302 may also include signaling from the access node, in particular when it comes to access category selection for accesses that are triggered by, e.g., signaling with the access node.

When an event 304 occurs triggering a need for the UE 12 to request an access to the network, such as a need to transmit uplink data when the UE 12 is in idle mode, the UE 12 first determines the access category in action 306, based on the available rules including those which were obtained in action 302 After determining the access category for this particular access, the UE 12 then reads access barring indications typically part of the broadcasted system information in action 308. It then performs a barring check in action 310, using the determined access category and the access barring indication as input. If the barring check results in that the access was “barred” the UE will not perform an access and instead wait for a period, such as a period indicated in the access barring indication. In case the barring check results in that the access was “not barred” the UE 12 can proceed with random access in action 312, and RRC connection establishment procedure.

The development of a unified access control mechanism for access barring is currently ongoing.

The access control and in particular the barring mechanisms are used to prevent UE's from sending an access request. There are also other mechanisms available for controlling the load in the network. For example, in situations when access barring allows an access attempt and a UE is allowed to send a Preamble 201 and an RRC Connection Request, 203 or any equivalent message, here from referred to as msg3, the network may anyway respond with an RRC Connection Reject message. The reasons for this reject message may for example be, e.g., an overload situation that is not yet reflected on in the parameters governing the access barring. It can also be other reasons.

Before an RRC Connection Reject or an RRC Connection Setup or equivalent response message is sent to the UE or before an msg3 leads to allocation of further resources, e.g., for subsequent signaling, the network side typically evaluates the reason for why the access request was sent. In msg3, the UE indicates an “establishment cause” to reflect the reason for why the access request was sent. In EUTRAN/LTE, this is a 3-bit field that can take the values: Emergency, High Priority Access, mt-Access, mo-Signaling, mo-Data, delayTolerantAccess-v1020, mo-VoiceCall-v1280, spare.

Mt-Access means Mobile-Terminated access, which is typically used for an access request triggered by a UE that want to respond to a received paging message from the network.

Mo-Signaling means Mobile-Originated signaling, which is typically used when a signaling procedure, such as a Registration Procedure from the UE triggers the access request.

Mo-Data means Mobile-Originated data, which is typically used for an access request triggered by some data to be transmitted from the UE.

DelayTolerantAccess-v1020 is typically used by UEs, which are configured for delay tolerant services, such as some Machine-Type Communications (MTC) services.

mo-VoiceCall-v1280 is used by a UE triggering an access request caused by a Mobile-Originated voice call.

There is also a standard applicable for narrowband LTE and for this, the establishment cause field is slightly different.

The establishment cause value sent in msg3 originates from higher layers in the UE. Non-Access Stratum is the term for the layers above the access layers. Lower layers, or access layers in the UE receive the establishment cause together with a call type indication for each event that should trigger an access request. The call type typically is an indication that controls the access barring in the UE RRC layer of an EUTRAN/LTE capable UE, according to the old access classes as described above, and indicate how the UE should perform the evaluation of access barring. Different call types are: originating signaling, emergency calls, originating MMTEL voice, originating MMTEL video, originating Short Message Service (SMS),originating SMS over Internet Protocol (SMSolP), terminating calls, originating calls, mobile originating Circuit-Switched (CS) fallback.

Call Type, establishment cause and type of trigger, e.g., what type of NAS message or event that triggers a request to lower layers for transmitting an access request to the network, in combination with access class and barring parameters defines how lower layers shall behave both with respect to barring and what to include in a subsequent msg3 as establishment cause.

3GPP System Architecture

FIG. 4 depicts Planes in a communications system. A communication system, such as a 3GPP system, is normally functionally divided vertically into User Plane 401, Control Plane 402 and Management Plane 403 as illustrated in FIG. 4. This division allows independent scalability, evolution and flexible deployments. The user plane 401, which carries the user data traffic, contains functions and protocols related to user data transfer such as segmentation, reassembly, retransmission, multiplexing, ciphering and so forth. In the control plane 402, which carries signaling traffic, we find the protocols and functions needed to setup, release, control and configure the user plane. The control plane 402 also contains functions and protocols related to for example UE mobility, UE authentication, control of user sessions and bearers, also known as service data flows or QoS flows. In the Management plane 403, which carries administrative traffic, we find for example Operations and Maintenance (O&M) and provisioning functions. There exists normally no distinct division between control plane 402 and management plane 403 but typically the control plane 402 operates in a faster time scale (e.g. seconds) than the management plane 403, e.g. hours. Then the User Plane 401 operates typically in the fastest time scale, e.g. milliseconds.

FIG. 5 depicts domains and strata in a 3GPP system. FIG. 5 illustrates another division of the 3GPP system, into domains and strata. There are a number of domains, most important are the UE 12, the Access Network (AN) 502 and the Core Network (CN) 503. It needs to be understood that typically the UE 12, the AN 502 and the CN 503 all contains User Plane 401, Control Plane 402 and Management Plane 403 functions.

The UE 12 is a device allowing a user access to network services. It is typically a wireless terminal, such as a smartphone, equipped with a User Services Identity Module (USIM). The latter contains the credentials in order to unambiguously and securely identify itself. The functions of the USIM may be embedded in a standalone smart card, but may also be realized, e.g., as software in a software module.

The AN 502, also known as the Radio Access Network, RAN, comprises access nodes, or base stations, also known as eNBs or gNBs, which control the radio resources of the access network and provides the UE 12 with a mechanism to access the core network 503. The Access Network 502 is dependent of the radio access technology used in the wireless interface between the UE 12 and Access Network 502. Thus, we have different flavors of access network 502 for different radio access technologies, such as E-UTRAN supporting LTE or E-UTRA radio access technology and NG-RAN supporting New Radio (or 5G) type of radio access technology

The CN 503 comprises network nodes which provide support for the network features and telecommunication services, such as the management of user location information, control of network features and services, the switching and transmission of signaling and user data. The core network 503 also provides the interface towards the External Network 507. There are different types of core networks 503, for different 3GPP system generations. For example, in 4G, also known as the Evolved Packet System (EPS), we find the Evolved Packet Core (EPC). Developed as part of the 5G System (5GS) we find the 5G Core (5GC).

Moreover, the core network 503 is access-agnostic and the interface between the access network 502 and core network 503 enables integration of different 3GPP and non-3GPP access types. For example, an Access Network 502, also known as E-UTRAN, supporting LTE or E-UTRA radio access technology as well as an access network, also known as NG-RAN, supporting New Radio type of radio access technology can both be connected to a 5G type of core network 503, also known as 5GC.

The External Network 507 represents here a network outside of the 3GPP domain, such as the public Internet.

As seen in FIG. 5, 3GPP system is also horizontally divided into the Access Stratum (AS) 504 and Non-Access Stratum (NAS) 505 reflecting a protocol layering hierarchy. In the AS 504 we find functions which are related to the wireless portion of the system such as transport of data over the wireless connection and managing radio resources. The AS 504 typically contains functions in the access network 502 and the dialogue, using corresponding protocols, between the UE 12 and the access network 502. In the NAS 505, which can be seen as higher in the protocol layering hierarchy than AS 504, we find the functions which are not directly dependent on the radio access technology and typically the functions in the core network and the dialogue (using corresponding protocols) between the UE 12 and the core network 503.

In FIG. 5, also the Application 506 is illustrated above NAS 505. The Application 506 may contain parts in the UE 12, the core network 503 and the External network 507.

FIG. 6 depicts protocol layers in user plane and control plane of a 3GPP system

The control plane 402 and User Plane 401 of the Access Stratum 504 and Non-Access Stratum 505 are further divided into protocol layers. As illustrated in FIG. 6, in the Access Stratum (AS) 504, there is one protocol layer in the control plane 402, namely the Radio Resource Control (RRC) layer 601. As the RRC layer 601 is part of the Access Stratum 504, it is dependent on the type of radio access technology used between the UE 12 and Access Network 502. Thus, there are different flavors of RRC 601 for different radio access technologies, e.g. one type of RRC layer 601 for each of UTRA, E-UTRA and New Radio type of radio access technologies.

Further, in the Access Stratum 504 there are also a number of protocol layers in the user plane 401, such as the Physical (PHY) layer 611, Medium Access Control (MAC) layer 612, Radio Link Control (RLC) layer 613 and Packet Data Convergence Control (PDCP) layer 614. For New Radio, we also expect a new layer in the AS 504, above PDCP 614, here denoted New Layer (NL) 615. All protocol layers, both in the User Plane 401 and Control Plane 402 of the Access Stratum 504 are terminated in the Access Network 502 in the network side, such as the eNB or the gNB.

the Non-Access Stratum (NAS) 505, there are multiple protocol layers in the control plane 402. In EPS (Evolved Packet System, also known as 4G or LTE) these layers are known as EMM (EPS Mobility Management) 603 and ESM (EPS Session Management) 604. In the 5G system, we will find protocol layers performing the equivalent functions of EMM 603 and ESM 604, such as the Connection Management (CM) 605.

Further, in the Non-Access Stratum (NAS) 505, there are multiple protocol layers in the user plane 401, such as the Internet Protocol (IP) 616.

The Application 506 resides above the NAS 505, and interacts with the user plane 401 and in some cases also the control plane 402.

UE States and State Transitions

In the 3GPP system, for each protocol layer there is a state machine, reflecting the UE states of the particular protocol layer. In the state machine of the RRC layer 601 for NR radio access technology, according to 3GPP TS 38.804 v14.0.0 (2017-03), three states are specified as illustrated in FIG. 7: RRC_IDLE 701, RRC_INACTIVE 702 and RRC_CONNECTED 703. FIG. 7 depicts RRC states for NR.

The RRC states reflect the UE's activity level where RRC_IDLE 701 is typically used when the UE has no ongoing data traffic (thus no activity) and RRC_CONNECTED 703 when the UE needs to send and/or receive data. RRC_INACTIVE 702 may be used as an alternative state instead of RRC_IDLE 701 when the UE has no or low activity.

The procedure to enter RRC_CONNECTED 703 from RRC_IDLE 701 is known as the “RRC connection establishment” procedure. Before the RRC connection establishment the UE will be subject to Access control, including an access barring check as described above.

A UE in RRC_CONNECTED 703 will typically after a while, typically by order of a network node (such as the gNB), transit to RRC_INACTIVE 702, due to inactivity, using what is known as the “RRC Inactivation” procedure. Then, after even longer period of inactivity it will again enter RRC_IDLE 701 using e.g. the RRC Connection Release procedure. A UE in RRC_INACTIVE 702 needs to again enter RRC_CONNECTED 703 in order to transmit or receive data. Alternatively, the UE may remain in Inactive for as long as it remains in a certain network area, or it may be paged by the network to transition from RRC_INACTIVE 702 to RRC_IDLE 701.

The procedure for entering RRC_CONNECTED 703 from RRC_INACTIVE 702 is sometimes referred to as an “RRC Resume” (or “Activation”) procedure. The RRC Resume procedure is currently being standardized and details are yet to be set, but it is expected to require much less signaling than the RRC connection establishment procedure, since e.g. processing resources, transport resources and security association in the network are preserved in RRC_INACTIVE 702 and thus there is typically no need to establish those in the RRC Resume procedure. Therefore the latency before user data can be exchanged between the UE and the network is typically much shorter for a UE in RRC_INACTIVE 702 than for a UE in RRC_IDLE 701. On the other hand, a UE in RRC_INACTIVE 702 consumes a little more power as well as resources (e.g. memory) than a UE in RRC_IDLE 701.

For LTE, a similar RRC state machine is specified and the functionality similar to the NR RRC_INACTIVE state as well as an RRC Resume procedure already exists.

FIG. 8 depicts NAS states represented by the CM states. In the Non-Access Stratum (NAS), among others, a protocol layers Connection Management (CM) state machine is during specification, with, according to 3GPP TS 23.501, two states: CM-IDLE 801 and CM-CONNECTED 802, as illustrated in FIG. 8. These states reflect the level of NAS control plane connectivity between the UE and the network. A UE in CM-IDLE state 801 has no NAS signaling connection established with the network. A UE in CM-IDLE 801 is also in RRC_IDLE 701 and thus it needs to establish an RRC connection to enter RRC_CONNECTED 703 and CM-CONNECTED 802. On the other hand, a UE in CM-CONNECTED 802 may be in either RRC_INACTIVE 702 or RRC_CONNECTED 703, depending on the UE activity level.

3GPP Quality of Service (QoS) Architecture

QoS in the Evolved Packet System (EPS)

Please see FIG. 9a which depicts EPS bearer architecture (3GPP TS 36.300) comparing UE, eNB, Serving Gateway (S-GW), Packet Data Network Gateway (P-GW) and Peer entity.

In the 3GPP 4G system, also known as the Evolved Packet System (EPS), a fundamental part of the QoS architecture is the EPS bearer. The term bearer when used herein may mean an information transmission path of defined capacity, delay and bit error rate, etc. The EPS bearer concept enables bearer level QoS control in the EPC/E-UTRAN. This is realized by making sure that all the traffic mapped to the same EPS bearer receives the same packet forwarding treatment, e.g. scheduling policy, queue management policy, rate shaping policy, RLC configuration, etc. In addition, the Policy and Charging Control (PCC) framework allows an optional enforcement of service level QoS control on the granularity of Service Data Flows (SDF). An SDF is an aggregate of packet flows sharing the same characteristics and the packet flow typically represents user data of the End-to-end service.

The EPS bearer is associated with a set of packet filters comprising the bearer Traffic Flow Template (TFT). Therefore, packets are routed to different bearers based on the filters in the TFT which uses information such as source and destination IP address, port number and the protocol information, for example. For uplink packets, the filtering is performed in the UE. For downlink packets, the filtering is performed in the Packet Data Network Gateway (P-GW) network node.

Each EPS bearer is associated with a QoS class identifier (QCI). The QCI is used as a reference to a specific packet forwarding behavior (e.g. packet loss rate, packet delay budget) to be provided to an SDF. This may be implemented in the access network by the QCI referencing node specific parameters that control packet forwarding treatment (e.g. scheduling weights, admission thresholds, queue management thresholds, link layer protocol configuration, etc.), that have been pre-configured by the operator at a specific node(s) (e.g. eNodeB).

In the Access Stratum over the radio interface, the EPS bearer is mapped on a Radio Bearer (RB). A radio bearer which carries user plane data is known as a Data Radio Bearer (DRB). It may also be a signaling radio bearer, or an SRB, like for example an SRB1 or SRB2 used to carry control plane information both for Access Stratum as well as Non-Access Stratum.

The External Bearer in FIG. 9a transports data between the PDN GW and a peer entity in an external network.

The E-RAB in FIG. 9a means Evolved Universal Terrestrial Radio Access Network Radio Access Bearer. An E-RAB transports the packets of an EPS bearer between the UE and the EPC.

The S5/S8 Bearer is depicted in FIG. 9a. An S5/S8 bearer transports the packets of an EPS bearer between a Serving GW and a PDN GW.

The S1 Bearer in FIG. 9a transports the packets of an E-RAB between an eNodeB and a Serving GW.

QoS in the 5G System

The 5G QoS model supports QoS flow based framework. The QoS flow is the finest granularity of QoS differentiation in the 5G system. All traffic mapped to the same 5G QoS Flow receive the same forwarding treatment (e.g. scheduling policy, queue management policy, rate shaping policy, RLC configuration, etc.). Providing different QoS forwarding treatment requires separate 5G QoS Flow.

A QoS Flow ID (OR) is used to identify a QoS flow in the 5G system. Each QoS flow is, among others, associated with a 5G QoS Indicator (5QI). A 5QI is a scalar that is used as a reference to 5G QoS characteristics i.e. access node-specific parameters that control QoS forwarding treatment for the QoS flow (e.g. scheduling weights, admission thresholds, queue management thresholds, link layer protocol configuration, etc.).

A PDU Session is an association between the UE 12 and an External Network 507 that provides an exchange of data packets.

The QoS parameters of a QoS flow are provided to the (R)AN over N2 at PDU Session or at QoS flow establishment and when 5G-RAN is used at every time the User Plane is activated. QoS parameters may also be pre-configured in the (R)AN for non-GBR QoS flows (i.e. without the need to be signaled over N2).

The network provides QoS rules to the UE for the classification and marking of UL traffic, i.e. the association of uplink traffic to QoS flows. These rules can be explicitly signaled over N1, pre-configured in the UE or implicitly derived by UE from reflective QoS. A QoS rule contains the QFI of the QoS flow, packet filters and corresponding precedence values. A default QoS rule is provided to the UE at PDU Session establishment, i.e. the default QoS rule shall include a packet filter which may be a match-all packet filter and an evaluation precedence value with highest possible value. In addition, pre-authorized QoS rules may be provided to the UE. QoS rules can be also provided at QoS flow establishment.

The principle for classification and marking of User Plane traffic to QoS Flows and mapping to AN resources is illustrated in FIG. 9b. FIG. 9b depicts packet classification and mapping in the 5G system (3GPP TS 23.501)

In DL incoming data packets are classified based on SDF filters. The CN conveys the classification of the User Plane traffic belonging to a QoS flow through an N3 User Plane marking using a QFI. All A-type QoS flows are allocated a standardized or pre-defined QFI value, and the standardized or pre-defined QFI value is associated with a specific 5QI value and default ARP. The AN binds QoS flows to AN resources (i.e. Data Radio Bearers in case of in case of 3GPP RAN). There is no strict 1:1 relation between QoS flows and AN resources. It is up to the AN to establish the necessary AN resources to map the QoS flows to DRBs so that the UE receives the OR (and reflective QoS can be applied).

In UL, the UE classifies packets based on the uplink packet filters in the QoS rules and conveys the classification of the User Plane traffic belonging to a QoS flow through a User Plane marking using the OR in the corresponding QoS rule. The UE binds QoS flows to AN resources.

### SUMMARY

An object of embodiments herein is to improve the performance of a wireless communications network.

According to a first aspect of embodiments herein, the object is achieved by a method performed by a User Equipment, UE, for controlling a data transmission over a bearer in a wireless communications network. When the bearer is established, the UE determines an access category for the data to be transmitted over the bearer. The UE associates the determined access category with the bearer. When the data is to be transmitted over the bearer, the UE performs barring check of the access category associated with the bearer. When the access category associated with the bearer is barred, the UE decides to not transmit the data, and when the access category associated with the bearer is not barred, the UE decides to initiate a procedure to transmit the data over the bearer.

According to a second aspect of embodiments herein, the object is achieved by a User Equipment, UE, for controlling a data transmission over a bearer in a wireless communications network. The UE is configured to:
When the bearer is established, determine, an access category for the data to be transmitted over the bearer, e.g. by means of a determining module in the UE,
associate the determined access category with the bearer, e.g. by means of a associating module in the UE 102,
when the data is to be transmitted over the bearer, perform barring check of the access category associated with the bearer,
when the access category associated with the bearer is barred, decide to not transmit the data, e.g. by means of a deciding module in the UE 102, and
when the access category associated with the bearer is not barred, decide to initiate a procedure to transmit the data over the bearer e.g. by means of the deciding module in the UE 102.

An advantage of embodiments herein is that the same access categories and barring information may be used in all RRC states, such as RRC_IDLE, RRC_INACTIVE and RRC_CONNECTED, thus limiting the amount of signaling and data to be configured and stored in the UE which in turn results in that the performance of the wireless communications network is improved.

### BRIEF DESCRIPTION OF THE DRAWINGS

Examples of embodiments herein are described in more detail with reference to attached drawings in which:

FIG. 1 is a schematic block diagram according to prior art.

FIG. 2 is a sequence diagram according to prior art.

FIG. 3 is a sequence diagram according to prior art.

FIG. 4 is a schematic block diagram according to prior art.

FIG. 5 is a schematic block diagram according to prior art.

FIG. 6 is a schematic block diagram according to prior art.

FIG. 7 is a flowchart according to prior art.

FIG. 8 is a flowchart according to prior art.

FIG. 9a is a schematic block diagram according to prior art.

FIG. 9b is a schematic block diagram according to prior art.

FIG. 10 is a schematic block diagram depicting embodiments of a radio communications network.

FIG. 11 is a flowchart depicting embodiments of a method.

FIG. 12 is a sequence diagram according to embodiments herein.

FIG. 13 is a sequence diagram according to embodiments herein.

FIG. 14 is a schematic block diagram according embodiments herein.

FIG. 15 is a flowchart depicting embodiments of a method.

FIG. 16 is a schematic block diagram illustrating embodiments of a UE.

FIG. 17 schematically illustrates a telecommunication network connected via an intermediate network to a host computer.

FIG. 18 is a generalized block diagram of a host computer communicating via a base station with a user equipment over a partially wireless connection.

FIGS. 19 to 22 are flowcharts illustrating methods implemented in a communication system including a host computer, a base station and a user equipment.

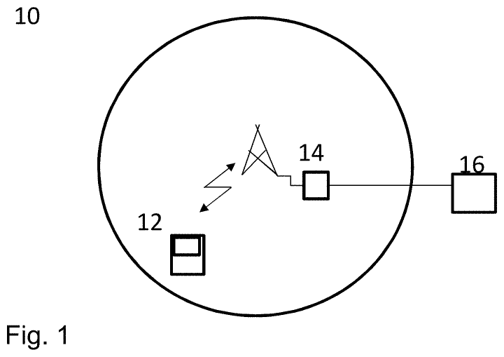

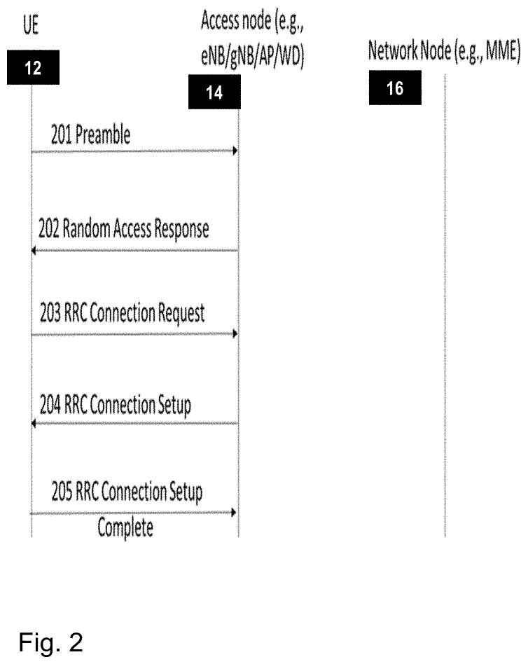

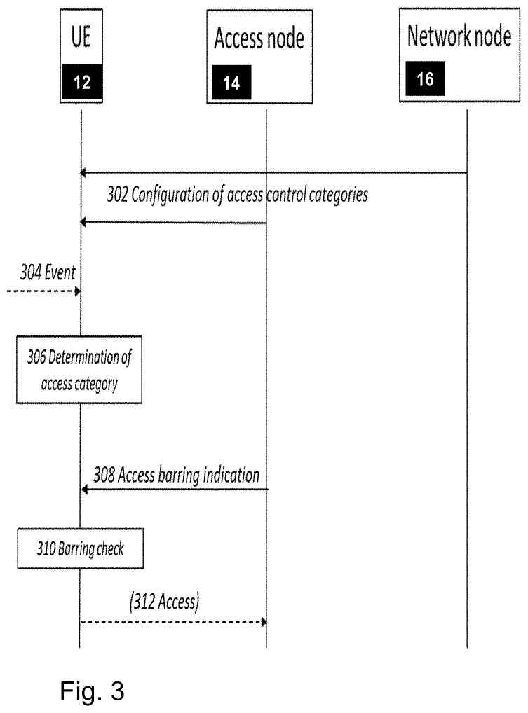

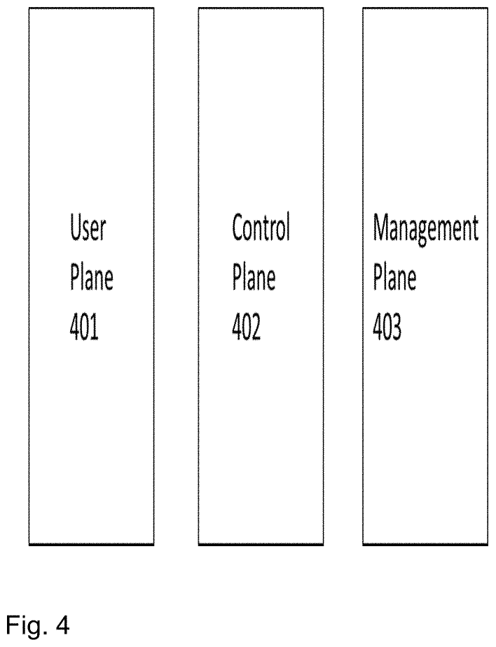

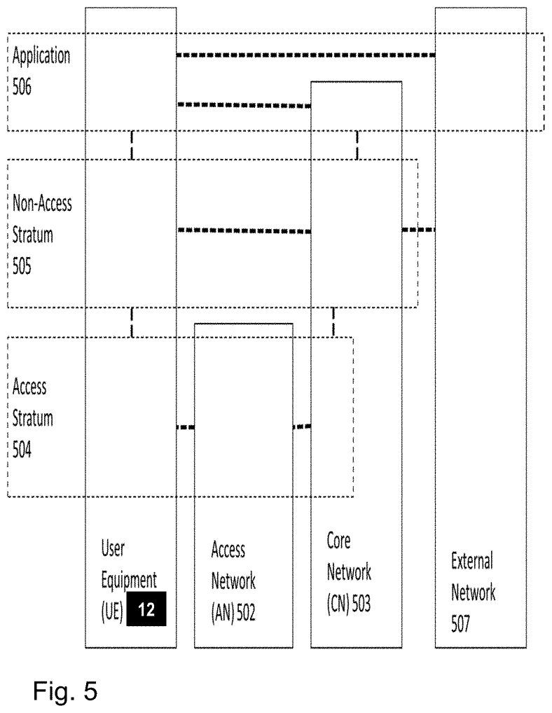

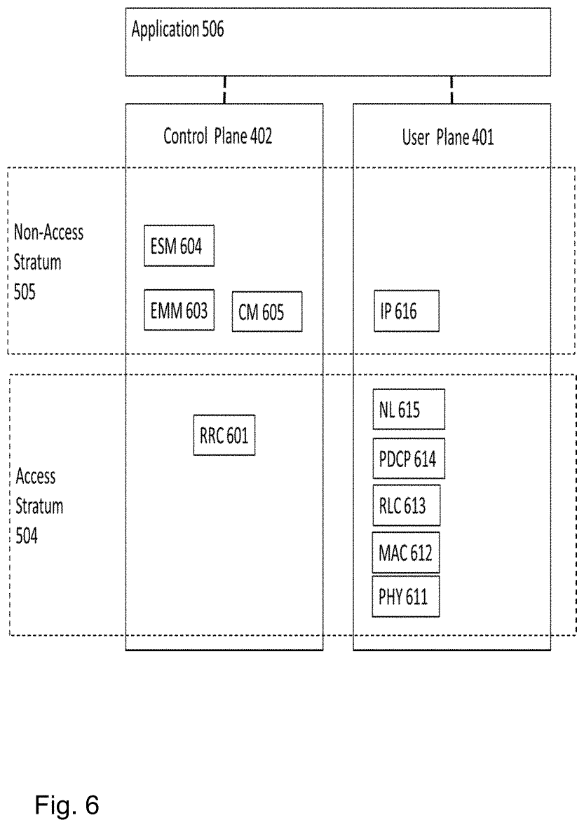

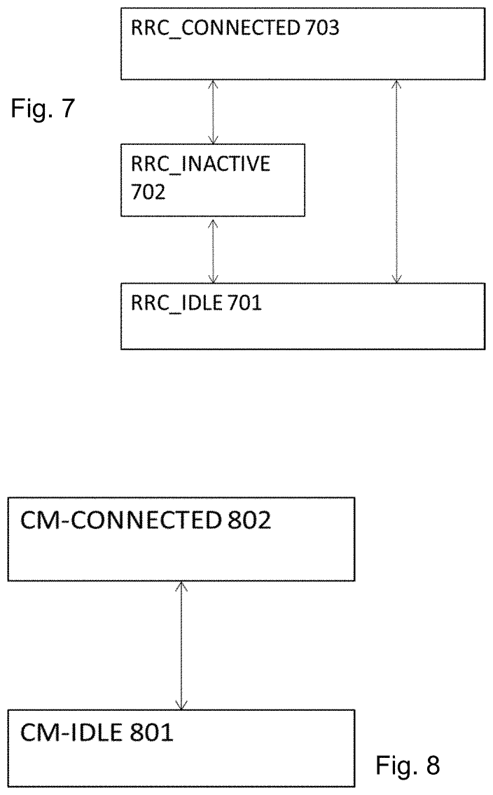

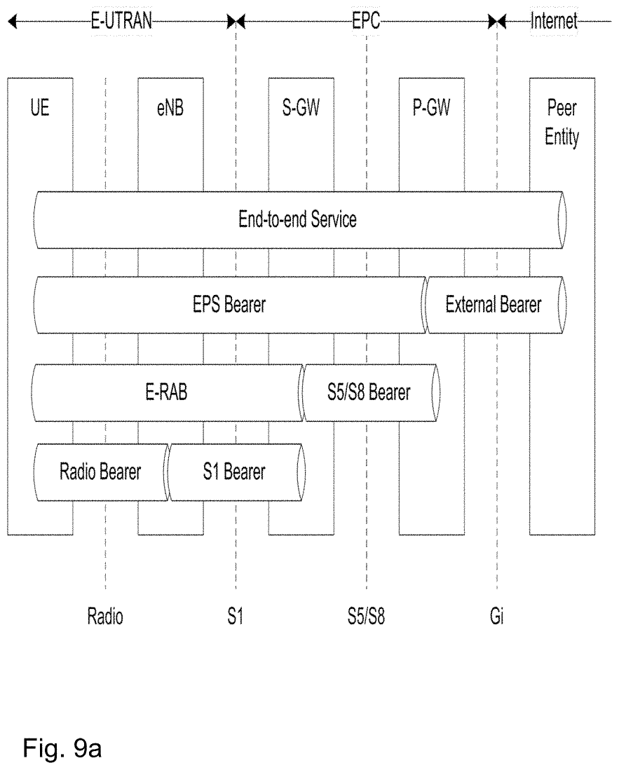

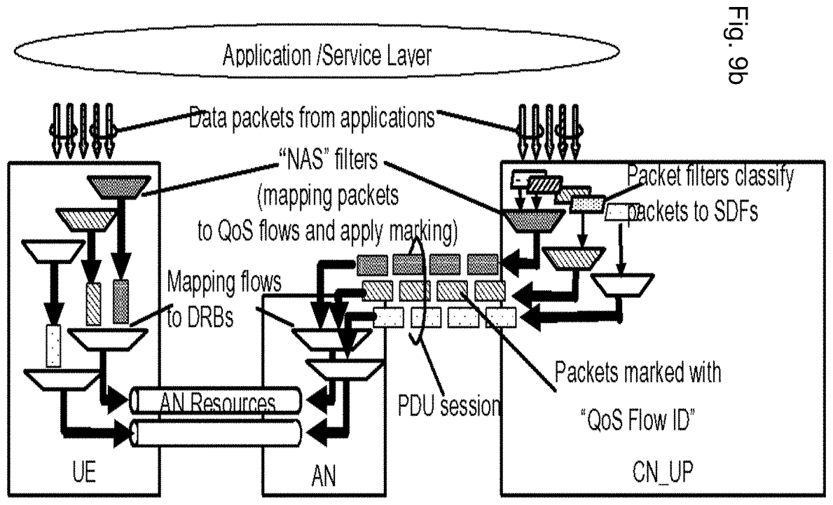

### DETAILED DESCRIPTION

As a part of developing embodiments herein a problem will first be identified and discussed.

In the current 3GPP systems, access control normally applies only for UEs in idle mode (RRC_IDLE, CM-IDLE). During high network load or e.g. due to maintenance such a software upgrade or a restart of network equipment, an access control mechanism is used to limit the amount of UEs performing RRC connection establishment and thus keeping the load under control and avoid complete overload, yet allowing high priority traffic (such as emergency calls).

In 5G, it is expected that a large population of the UEs will be in connected mode, such as CM-CONNECTED combined with RRC_INACTIVE or RRC_CONNECTED, due to more traffic per user and requirements for short latency when sending data from a low activity level. Because of this, during high network load, an access control mechanism applying only to UEs in RRC_IDLE is expected to be of limited use.

Thus, there is a need to also provide efficient access control of UEs in RRC_INACTIVE and RRC_CONNECTED.

However, when the RRC layer in the UE is in RRC_INACTIVE and RRC_CONNECTED, the NAS is in CM-CONNECTED state and in this state any user data is passed directly from the UE NAS to UE AS within the user plane. In the current access control used in RRC_IDLE and CM-IDLE, a request is passed from the NAS control plane to the AS control plane (RRC) to trigger the access control and subsequent establishment of RRC connection. In some cases, such as when a UE in CM-CONNECTED triggers a NAS procedure such as a registration procedure, a request is passed in the control plane, but not during uplink data transfer. Thus, during uplink data transfer only, there is currently no way of associating a NAS control plane indication to the RRC Control plane layer, as is done in idle mode and for NAS Control plane signaling, i.e., establishment cause and call type, as described above. This means that the RRC Control plane has no obvious way or information that it can perform an access control procedure on.

Thus, in particular for RRC_INACTIVE and RRC_CONNECTED and when CM-CONNECTED, new solutions are desired for mobile originating traffic during e.g. system overload, to limit addition of air interface load. Such a new solution should preferably be able to operate in a similar way as for RRC_IDLE/CM-IDLE, such that access control can both prevent a UE originating request being sent (barring) and as well allow a network access node (such as a gNB) to determine, based on indication whether a request should be granted or not (corresponding to establishment cause).

An object of embodiments herein is therefore to improve the performance of a wireless communications network.

Embodiments herein relate to wireless communication networks such as cellular networks. A method, user equipment and network nodes for transmitting and receiving messages related to wireless access are disclosed. Embodiments herein may relate to User Plane Access Control.

Some example embodiments provides a way of using access control to limit a UE to transmit data, in an AS state such as RRC_INACTIVE and RRC_CONNECTED, when the NAS layers is in connected mode (such as CM-CONNECTED).

In a first aspect of embodiments herein, access category information is determined when a bearer is both established, reconfigured and/or released.

In a second aspect of embodiments herein, the determined access category information is associated with a bearer.

In a third aspect of embodiments herein, when data belonging to a bearer is to be transmitted, the access category information associated with that bearer is used to perform an access barring check.

Embodiments herein provide an efficient access control for connected mode UEs and limiting the aggregate uplink data traffic from UEs.

An advantageous feature is that the same access categories and barring information can be used in all RRC states, such as RRC_IDLE, RRC_INACTIVE and RRC_CONNECTED, thus limiting the amount of signaling and data to be configured and stored in the UE.

Another advantageous feature is that there is no or limited impact on the NAS control plane and yet providing access control in NAS connected mode such as CM-CONNECTED state.

In some embodiments, implementation of access category information in CM-CONNECTED follow the same principles as for CM-IDLE and for each activity over a QoS flow that is associated with a radio bearer the NAS Control plane procedure used for producing the access category information is repeated. This is advantageous if, e.g., there are new rules provided from the network.

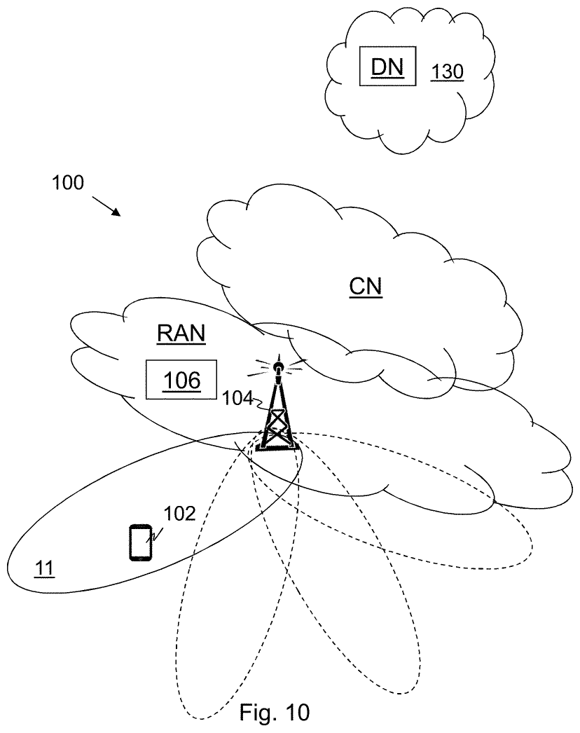

Examples of embodiments herein relate to wireless communication networks in general. FIG. 10 is a schematic overview depicting a wireless communications network 100. The radio communications network 100 comprises one or more RANs and one or more CNs. The radio communications network 100 may use a number of different technologies, such as Wi-Fi, Long Term Evolution (LTE), LTE-Advanced, 5G, New Radio (NR), be a radio communications network pursuant to 3GPP LTE/EUTRA specifications, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 100, wireless devices e.g. a UE 102 such as a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

The radio communications network 100 comprises an access node 104 providing radio coverage over a geographical area, a service area 11, which may also be referred to as a beam or a beam group of a first radio access technology (RAT), such as 5G, LTE, Wi-Fi or similar. The access node 104 may be a transmission and reception point e.g. a radio access network node such as a Wireless Local Area Network (WLAN) access point or an Access Point Station (AP STA), an access controller, a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the service area served by the access node 104 depending e.g. on the first radio access technology and terminology used. The access node 104 may be referred to as a serving radio network node and communicates with the UE 102 with Downlink (DL) transmissions to the UE 102 and Uplink (UL) transmissions from the UE 102.

Methods for handling such as e.g. controlling a data transmission in the radio communications network 100, is performed by the UE 102. As an alternative, a Distributed Node (DN) and functionality, e.g. comprised in a cloud 130 as shown in FIG. 10 may be used for performing or partly performing the methods.

The technology described herein may be used in various wireless systems and is not restricted to 3GPP EUTRA/LTE systems and 3GPP Next Generation systems deploying New Radio, even though such systems will serve as examples. Access control is a mechanism that may be applicable to any system where user, service or other differentiation and load management of access is needed. Other examples may be wireless access pursuant to IEEE 802 standards, such as IEEE 802.11 WLAN standard or the IEEE 802.16 standard, but also 3GPP GSM evolutions.

Referring again to FIG. 10, which may illustrate the wireless communications network 100, for example being pursuant to 3GPP LTE/EUTRA specifications.

In the wireless network 100 the UE 102 is illustrated. The UE 102 may can request access to and communicate with the access node 104. The access node 104 is typically part of an access network such as a RAN. The access node 104 may in turn be connected to a network node 106, typically part of the core network CN that for example may provide internet access. In LTE, the access node 104 is commonly referred to as eNB, whereas in other standards, it may be referred to as Node B, Base Station, or simply Access Point. In the development of next generation radio access technology for 5G in 3GPP, also known as “New Radio”, the access node 104 is sometimes referred to as “gNB”. It should be noted that the illustration in FIG. 10 is traditional in the sense that it provides a view of “physical entities”, but to a person skilled in the art, it should be obvious that for example the access node 104 or the network node 106 may be implemented using distributed or centralized processing capacity such as using what is also known as Network Function Virtualization (NFV). Similarly, they may also be implemented in the same physical entity. For purposes of this example, the description will associate the nodes with certain functionality rather than restricting to certain implementations.

The access node 104 may communicate user information and signalling to and from the network node to the UE 102. The Wireless network 100 comprises in this figure four “cell” areas and one access node 104. It should be understood that any access network usually comprises several access nodes and thus several more areas or cells are thus served.

The network node 106 may be one of many nodes part of the core network CN. For example it may be a control plane node, e.g., an Mobility Management Entity (MME), in LTE, a Core Access and Mobility Management Function /Session Management Functions (AMF/SMF) according to 3GPP system architecture as specified in e.g. 3GPP TS 23.002 or 3GPP TS 23.501), for communicating control information with the UE 102, or it may be a user plane node Serving Gateway (SGW), or a User Plane Function (UPF) as specified in e.g. 3GPP TS 23.002 or 3GPP TS 23.501, for communicating user data information to the UE 102. Further, the network node 130 may be connected with other network nodes and work as a relay for information from these nodes to the UE. Such other network nodes may for example be a Packet Gateway (PGW) or similar.

The UE 102 may be in a valid combination of RRC state and NAS layer state. For example, in case of a 5G core network and a new radio type of access network and corresponding access node and network node, the UE may be in RRC_INACTIVE state and CM-CONNECTED state, or alternatively in RRC_CONNECTED and CM-CONNECTED. It should be understood that the UE may also be in RRC_IDLE and CM-IDLE.

For the detailed description embodiments herein, we as the example here assume the UE 102 may be connected to the network node 106 part of a 5G core network via an access node 104 part of an NR access network, also known as NG-RAN. It should be understood that a person skilled in the art is able to apply embodiments herein for other systems than 5G/NR, such as an UE connected to a network node 106 in a 5G core network or the EPC, via an access node 104 part of an LTE access network.

For the detailed description of embodiments herein, we as the example here also assume the UE 102 is in the RRC_INACTIVE and CM-CONNECTED states. It should be understood that a person skilled in the art will be able to apply embodiments herein also in another combination of UE states, such as RRC_CONNECTED and CM-CONNECTED.

Actions of Some Embodiments Herein

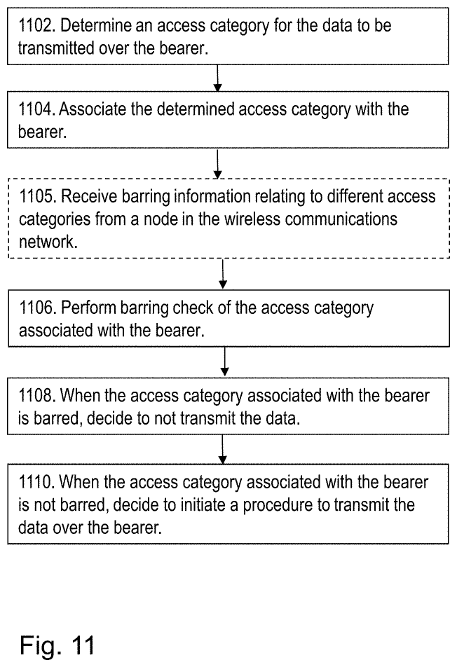

Example embodiments of a flowchart illustrating embodiments of a method performed by the UE 102 for handling such as e.g. controlling a data transmission over a bearer in the wireless communications network 100 is depicted in FIG. 11. The method comprises one or more of the following actions which actions may be taken in any suitable order. Actions that are optional are depicted as dashed boxes in FIG. 11.

Action 1102.

To be able to decide whether or not to transmit the data in a data transmission over a bearer, the access category for the data is needed for a barring check of the bearer. This is to be able to differentiate between bearers during the access barring check, i.e. to prioritize some bearers on front of others. Thus, when the bearer is established, the UE 102 determines an access category for the data to be transmitted over the bearer. Access categories for a bearer may e.g. be an existing standardized access category, an operator-defined access category, or a new type of access category used for a new type of services such as e.g. Ultra-Reliable Low-Latency Communication (URRLC).

The access category may e.g. be decided based on any one or more out of: QoS information, related to the bearer, QoS flow ID of the bearer, logical channel priority of the bearer, and a service that triggered the establishment of the bearer.

The established bearer may e.g. comprise any one out of: a created bearer, a reconfigured bearer, and resumed bearer.

Action 1104.

To be able to decide whether or not to transmit the data in a data transmission over the bearer, the bearer needs to be mapped to the determined access category for performing the barring check of the bearer. This is to be able to use the access category when an access barring check is to be performed for the data to be transmitted over the bearer. The UE 102 thus associates the determined access category with the bearer. To associate the determined access category with the bearer may e.g. mean that they are saved together such that when the bearer is looked up, it can be seen what access category the bearer has.

The information about the determined access category and information about the associated bearer may be stored as any one out of: A UE context information on Access Stratum AS level in the UE 102, and a UE context information on Non-Access Stratum NAS level in the UE 102. This is an advantage since when performing access barring check the access category can be read from the UE context. For example, the access category may be stored in the NAS UE context and kept even when the UE is in idle mode. When the UE enters connected mode, such as RRC_CONNECTED state, and data is to be transmitted, the access category is already determined.

Action 1105.

In some embodiments the UE 102 receives barring information relating to different access categories from a node such as an access node e.g. the eNB or the gNB, in the wireless communications network 100. Barring information when used herein may comprise dynamic information indicating whether access categories are barred, typically described as a barring factor, e.g. a probability such as 0-100%, for each access category. The barring information may be used by the UE 102 when determining whether an access category is barred during access barring check. For example, the UE 102 draws a random number uniformly distributed between 0 and 1 and compares then this random number with the barring factor for the access category in the access barring information. If the random number is less than the barring factor, the access barring check results in that the access attempt is not barred, i.e. the access attempt is allowed, and otherwise the access attempt is barred.

Action 1106.

When the data is to be transmitted over the bearer, the UE 102 performs barring check of the access category associated with the bearer. This is to see whether the data transmission using the bearer is barred or not, i.e. to see whether or not the bearer with the associated access category is allowed to be used for the data transmission. The barring check performed for this access category and bearer may be performed for an individual, or a set of, uplink data packets, for a certain time period, or for the duration of the established bearer.

In some of the embodiments, the UE 102 has received barring information relating to different access categories. In these embodiments the UE 102 may perform the barring check by checking the barring information for the determined access category associated with the bearer among the different access categories and associated bearers.

In some of the embodiments, the data to be transmitted over the bearer triggering the performing of the barring check e.g. relates to any of: The UE 102 transitioning mode from RRC, idle to RRC Connected, the UE 102 transitioning mode from RRC inactive to RRC connected, and the UE 102 being in RRC connected mode.

Action 1108.

When the access category associated with the bearer is barred, the UE 102 decides to not transmit the data.

Action 1110.

When the access category associated with the bearer is not barred, the UE 102 decides to initiate a procedure to transmit the data over the bearer.

Summarized

In action 1102, typically when a bearer is established or reconfigured or possibly even resumed, the UE 102 determines the access category for the data that would be transmitted over that bearer.

In action 1104, the UE 102 associates the access category determined in action 1102 with the particular bearer. This is a vital part of embodiments herein that a bearer should have an associated access category.

In action 1106, when data is to be transmitted over a particular bearer, the UE 102 uses the access category associated with the bearer in action 1104 to perform a barring check. In any situation when there is an access category information provided by the UE NAS layer in association with the data, the stored access category is not used, but instead the new information is used. In particular embodiments herein, the UE NAS can always refresh the stored access category with a new access category. This may be done at particular instances, or at any activity causing a radio bearer to trigger request for additional communication resources.

Bearer

In a 3GPP system, a “bearer” described in embodiments herein may be represented by, for example, either a radio bearer, such as a data radio bearer (DRB) or a signaling radio bearer (SRB), in e.g. a 3GPP Evolved Packet System (EPS) or a 3GPP 5G System (5GS), a Service Data Flow (SDF) in e.g. a 3GPP Evolved Packet System (EPS) or a 3GPP 5G System (5GS), an EPS bearer in e.g. a 3GPP Evolved Packet System (EPS) or a QoS flow in e.g. a 3GPP 5G System (5GS). How “bearer” is represented and applied is described in more detailed examples. It may also be a signaling radio bearer, or an SRB, like for example an SRB1 or SRB2 used to carry control plane information both for AS Stratum as well as Non-Access Stratum

Determination of Access Category

In action 1102, typically when a bearer is established or reconfigured, the UE 102 determines the access category for the data that would be transmitted over that bearer.

When establishing a connection between the UE 102 and the network, such as the access node 104 or the network node 106, at least one bearer is established.

Typically, in connection to this setup or modification of bearer mechanisms in the UE NAS Control plane will produce an access category for barring purposes.

3GPP EPS

In case of the 3GPP Evolved Packet System (EPS), “bearer” is represented by a data radio bearer (DRB) and/or an EPS bearer.

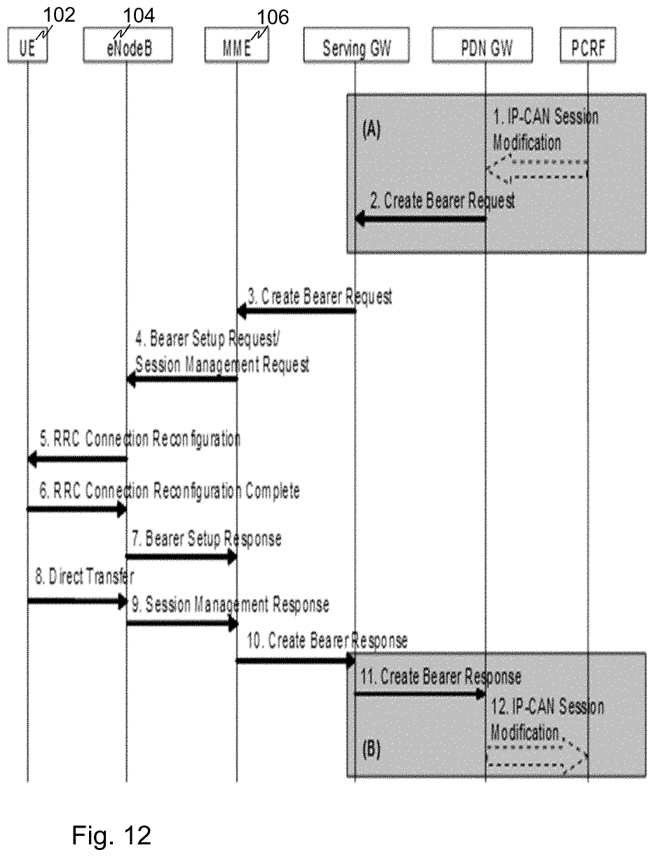

In one example, the UE 102 determines access category as part of a dedicated bearer activation procedure as illustrated in FIG. 12. FIG. 12 depicts a dedicated bearer activation procedure in 3GPP EPS (from 3GPP TS 23.401). The bearer activation procedure comprises the following actions:

1. A Policy and Charging Rules Function (PCRF) in the wireless communications network 100 may send an IP-Connectivity Access Network (IP-CAN) Session Modification to a Packet Data Network (PDN) Gateway (GW) in the wireless communications network 100. This is to provide an updated QoS policy when dynamic Policy and Charging Control (PCC) is deployed.

2. Based on the QoS policy, the PDN GW assigns the EPS bearer QoS parameters and sends a Create Bearer Request to the serving GW to provide these QoS parameters and other parameters and order the serving GW to setup a bearer with those parameters . . . .

3. The serving GW sends the Create Bearer Request to a Mobility Management Entity (MME).

4. According to embodiments herein, the access node 104, exemplified by the eNodeB in FIG. 12, receives a Bearer Setup Request from the network node 106, in FIG. 12 exemplified by the MME. In conjunction with this message, also an NAS message typically is transmitted, such as a Session Management Request or an ACTIVATE DEDICATED EPS BEARER CONTEXT REQUEST.

5. The access node 104 then transmits an RRC Connection Reconfiguration message to the UE 102, including DRB setup information. In conjunction with this message, also an NAS message typically is transmitted. When the UE 102 receives the RRC Connection Reconfiguration and the NAS messages, it uses the received information to determine access category.

In one example, in case of EPS, the NAS layer in the UE 102 may use the content of the NAS layer message (such as the Session Management Request or ACTIVATE 10 DEDICATED EPS BEARER CONTEXT REQUEST) to determine the access category. In one example, QoS information, such as the QCI value of the dedicated EPS bearer is used to determine access category.

In another example, the RRC layer of the UE uses information in the RRC Connection Reconfiguration message, such as logical channel priority to determine the access category.

In another example, the UE 102 determines access category as part of an Attach procedure. In this case, information received in the Attach Accept message, such as QoS information, such as QCI of the default EPS bearer, or the RRC Connection Reconfiguration message, such as logical channel priority. The UE 102 may also use other information not received in the message to determine the access category, such as information stored in the USIM, for example Access Class, or based on the service that triggers the connection establishment such as when performing an emergency call.

In yet another example, the access category is determined as part of a Bearer modification procedure. In this case, information received in the Bearer Modification message, such as QoS information, such as QCI of the dedicated EPS bearer, or the RRC Connection Reconfiguration message, such as logical channel priority. The UE 102 may also use other information not received in the message to determine the access category, such as information stored in the USIM, for example Access Class, or based on the service that triggers the connection establishment such as when performing an emergency call.

6. The UE 102 then sends a RRC Connection Reconfiguration Complete message to the access node 104 to acknowledge the radio bearer activation.

7. The access node 104 sends a Bearer Setup Response to the MME to acknowledge the bearer activation.

8. The UE 102 then sends a Direct Transfer message to the access node 104, containing a Session Management Response.

9. The access node 104 forwards the received Session Management Response to the MME

10. The MME sends a Create Bearer Response to the Serving GW

11. The Serving GW sends the Create Bearer Response to the PDN GW

12. The PDN GW then an IP-CAN Session Modification to the PCRF.

3GP 5GS

In case of a 3GPP 5G System (5GS), “bearer” is represented by a data radio bearer (DRB) and/or QoS flow.

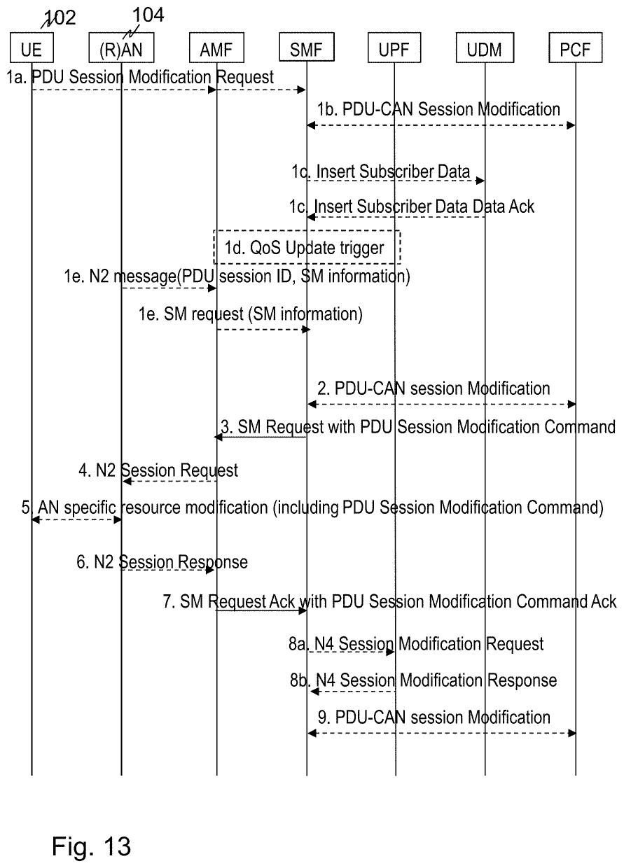

In one example, the UE 102 determines access category as part of a PDU session modification procedure as illustrated in FIG. 13. FIG. 13 depicts a PDU session modification procedure (3GPP TS 23.502 v0.3.0) comprising.

1a. The UE 102 sends a PDU Session Modification Request to an AMF in the wireless communications network 100 in order to initiate the PDU session modification procedure. The AMF sends the PDU Session Modification Request to a SMF in the wireless communications network 100.

1b. The Policy Control Function (PCF) may initiate a PDU-CAN Session Modification procedure towards the SMF upon e.g. policy decision in the wireless communications network 100.

1c. The SMF sends an Insert Subscriber Data message to a Unified Data Management (UDM) in the wireless communications network 100 and receives back an Insert Subscriber Data Ack.

1d. The SMF then triggers a QoS Update if needed to modify the PDU session parameters.

1e. The access node 104 sends an N2 message, with e.g. a PDU session ID, and Session Management (SM) information to the AMF.

2. The SMF may initiate a DU-CAN session Modification to the PCF in order to request e.g. new QoS policies.

3. The AMF sends a SIM Request with PDU Session Modification Command to the AMF.

4. The AMF sends an N2 Session Request to the access node 104.

5. The access node 104 sends a AN specific resource modification (including PDU Session Modification Command), such as an RRC Connection Reconfiguration message in case of an eNB or a gNB, to the UE 102 and receives back a PDU Session Modification Command ACK and, in case of an eNB or a gNB, an RRC Connection Reconfiguration Complete, when the UE 102 has modified radio resource configuration related to the radio bearer.

6. The access node 104 sends an N2 Session Response to the AMF to acknowledge the N2 PDU Session Request.

7. The AMF sends a SM Request Ack with PDU Session Modification Command Ack to the SMF.

8a. The SMF sends an N4 Session Request to a User Plane Function (UPF) in the wireless communications network 100.

8b. The UPF returns a Session Response to the SMF.

9. The SMF again invokes a DU-CAN session Modification to the PCF to notify the result of e.g. enforcing the modified QoS policies requested by the PCF in step 1b.

In one example, the UE 102 determines access category by the information in the received PDU session modification message, such as QoS information, such as 5QI. The UE 102 may also use other information, even including information that is not received in the message to determine the access category, such as information stored in the USIM, for example Access Class, or based on the service that triggers the connection establishment such as when performing an emergency call.

In another example, the access category is determined as part of a PDU session establishment procedure. In this example, the UE 102 determines access category by the information in the received PDU session establishment message, such as QoS information, such as 5QI. The UE 102 may also use other information not received in the message to determine the access category, such as information stored in the USIM, for example Access Class, or based on the service that triggers the connection establishment such as when performing an emergency call.

In yet another example, the UE 102 determines the access category when receiving a downlink data packet from the network, such as the User Plane Function (UPF). In this example, the UE 102 may determine the access category by using information contained in the data packet, such as a header in the packet, typically when deriving a new QoS rule when reflective QoS is used.

In another example, the access category is determined as part of a PDU session establishment procedure. In this example, the UE 102 determines access category by the information in the received PDU session establishment message, such as QoS information, such as 5QI, or the QoS flow ID.

Association of Access Category with a Bearer

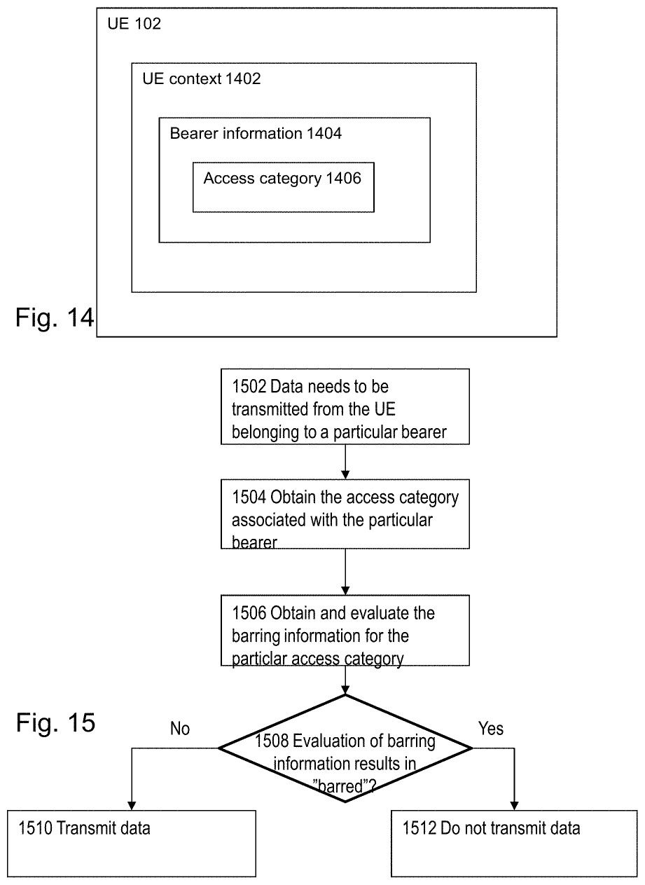

Please see FIG. 14. When establishing a connection between the UE 102 and the network, such as the access node 104 or the network node 106, also a UE context 1402 may be created, i.e., a descriptor of the connection between the network and the UE 102. The UE context may be stored in both the UE 102 and in the network, such as the access node 104 or the network node 106. As part of this UE context 1402, bearer information 1404 also may be stored. The bearer information 1404 includes description of the bearer, such as QoS information and how the particular bearer is mapped on user plane entities such as logical channel and physical channel. This bearer information 1404 may typically be provided from the network, such as when a bearer is established or modified. In action 1104, the UE 102 associates the access category determined in action 1102 with the particular bearer. This access category 1406 may be stored in the UE context 1402 and the bearer information 1404 is associated with an access category 1406. FIG. 14 depicts association between access category and a bearer.

In one example, the stored access category information is stored as context information on AS level. In particular, the access category is stored as context information on AS level. In one example, the access category is stored in a UE context in the AS control plane, such as in the RRC layer, and associated with radio bearer information part of this AS control plane UE context. In an alternative example, the access category is stored in a UE context in the AS user plane, such as in the PDCP or MAC layer and associated with a radio bearer as part of this AS user plane UE context.

In another example, the stored access category is stored as context information on NAS level. In particular, the stored access category is stored as context information on NAS level. In one example, the access category is stored in a UE context in the NAS control plane, such as the Session Management layer, and associated with EPS bearer or QoS flow information part of the UE context. In an alternative example, the access category is stored in a UE context in the NAS user plane, and associated with an EPS bearer or QoS flow information as part of this NAS user plane UE context.

In some embodiments, the access category or similar information (call type, establishment cause) stored in the UE context, may also be used as establishment cause in the transmission of a request to a network node.

Barring Check

In action 1106, when the UE has data to transmit over a particular bearer, the access category 1406 associated with that bearer is used by the UE 102 to perform an access barring check. Please see FIG. 15, where action 1502 corresponds to that the UE 102 has data to transmit, which belongs to a particular bearer. The UE 102 obtains the access category associated with the bearer and evaluates the barring information received from the network for this access category in action 1504 and action 1506. As an example, the barring information related to the access category is received from the network as part of system information. The UE 102 evaluates the barring information in action 1508. If the access category associated with the bearer is “barred”, the UE 102 does not transmit the data, see action 1512. If the access category associated with the bearer is not “barred”, the UE initiates the procedure to transmit the data, see action 1511. The FIG. 15 depicts barring check and relates to embodiments of FIG. 11 described above.

In one example, when the UE 102 is in CM-CONNECTED mode or in any situation when the UE NAS control plane does not provide any establishment causes, call types, access categories or any other means to perform access control in the UE AS layer, the associated access category of the specific bearer that triggers an increase of additional resources being requested over the air interface, e.g. due to uplink data to transmitted, is retrieved from the UE Context stored in the UE 102. This access category may then be used instead of new information generated by UE NAS control plane, when performing the barring check in the UE 102 AS. In a first alternative, the barring check may be performed in the UE AS Control Plane, e.g. RRC. In another alternative, the barring check may be performed in the UE AS User Plane, such as e.g. MAC or PDCP.

In another example, data is triggered from NAS for a certain QoS flow, and a stored access category is provided from UE NAS layer to UE AS layer, in a similar way as for CM-IDLE. The access category may then e.g. be stored for the bearer in the UE NAS User Plane layer and provided to the UE AS layer in the UE 102 for barring check. In a first alternative the barring check is performed in the RRC layer. In another alternative, the barring check is performed in UE AS User Plane, such as e.g. in the PDCP or MAC layer. The barring information may then be provided to the UE AS User Plane by the UE AS Control Plane (e.g. RRC) or from the network.

Barring check may be performed upon transition from RRC_IDLE to RRC_CONNECTED.

E.g. when the UE 102 is in RRC_IDLE, and needs to enter RRC_CONNECTED, such as when needing to transmit uplink data.

Barring check may further be performed upon transition from RRC_INACTIVE to RRC_CONNECTED.

E.g. when the UE 102 is in RRC_INACTIVE and it has a UE context stored, typically with bearer information for one or more bearers. When the UE 102 in RRC_INACTIVE needs to transmit uplink data, which is related to a bearer for which it has a stored bearer information, it uses the associated access category that is stored for the particular bearer when performing the barring check.

The UE 102 in RRC_INACTIVE checks the barring information that is transmitted by the network for the access category that is stored for the particular bearer, prior to transmitting the uplink data. If the associated access category is not barred, the UE 102 sends a resume request to the network node and if accepted, performs the transition to RRC_CONNECTED and transmits the uplink data.

As an alternative, the stored associated access category is included in the request message that the UE 102 transmits to the access network to request the transition to RRC_CONNECTED.

Barring check may further be performed upon in RRC_CONNECTED.

E.g. when in RRC_CONNECTED, and the UE 102 needs to transmit uplink data that is related to an existing bearer, the UE 102 uses the associated access category that is stored for the particular bearer when performing the barring check.

In one alternative the UE AS User Plane in the UE 102 checks whether the associated access category is barred using access barring information provided by the UE AS Control Plane (e.g. RRC) prior to transmitting the uplink data. In this alternative, the access category stored in a UE context in the UE AS user plane, such as the PDCP or MAC layer, and associated with a bearer, such as a radio bearer or a logical channel.

1. In one example, the access category associated with the bearer, such as a radio bearer or logical channel, is passed from the AS user plane, such as the PDCP or MAC layer, to the RRC layer, which performs the barring check and the result of the barring check is returned to the AS user plane, such as PDCP or MAC.

2. In another example, the current access barring information is forwarded by the RRC layer to the UE AS User Plane, such as in MAC or PDCP. The barring check is performed by the AS user plane using the provided access barring information and the access category associated with the bearer, such as a radio bearer or logical channel.

In another alternative, the UE NAS User Plane checks whether the associated access category is barred, using access barring information provided by either the NAS control plane or the AS control plane (such as RRC). In this alternative, the access category is stored in a UE context in the NAS user plane and associated with the bearer, such as an EPS bearer or a QoS flow.

1. In one example, the access category associated with the bearer, such as an EPS bearer or a QoS flow, is passed from the NAS user plane, to the NAS control plane or AS control plane, such as the RRC layer, which performs the barring check and the result of the barring check is returned to the NAS user plane.

2. In another example, the current access barring information forwarded either by the NAS control plane or the AS control plane (such as RRC) to the AS user plane. The barring check is performed by the NAS user plane using the provided access barring information and the access category associated with the bearer, such as an EPS bearer or a QoS flow.

It should be understood that the method to perform barring check upon in RRC_CONNECTED may also be used in other RRC states, such as RRC_IDLE and RRC_INACTIVE.

Thus according to embodiments herein, access control, e.g., by barring check is supported for all RRC states and different implementations, e.g., where barring checks are either performed in UE NAS, in UE AS, in the control plane or in the user plane of the UE 102 are described above.

It should also be noted that access control actions may also only selectively be triggered by bearer or QoS flow activity in different states. For example, in RRC_CONNECTED, it may be that any activity that triggers the UE MAC to send a preamble for use of random access resources may trigger an access control, whereas any activity that triggers the UE MAC to send scheduling requests on dedicated scheduling channels may not trigger an access control. It is thus not necessarily the case that all activity on a bearer needs to trigger access control procedures, irrespective of how they are implemented. According to some examples, access control may be directly connected to, e.g., what resources that are requested or needed.

Embodiments herein thus provide access control that operates in all RRC_States. One way of doing this is to associate an access category with a bearer, such as a radio bearer or QoS Flow, and use this associated access category for determining if resources should be allocated to traffic /activity over such bearers. Various implementations are described where the access category associated are either part of a stored context on UE NAS, on UE AS, in the control plane or in the user plane, and where barring checks are either done in the UE NAS or in the UE AS, e.g., PDCP or MAC layer.

Embodiments herein may further provide to allow access control to trigger selectively, dependent on what type of resources that are requested or will be used for activity over various bearers.

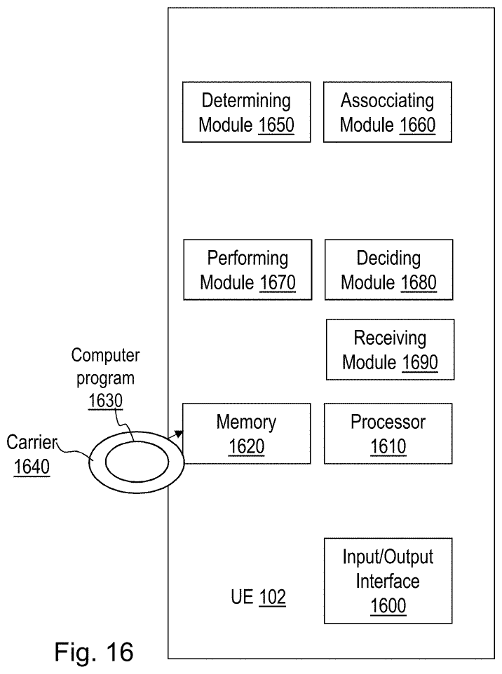

To perform the method actions e.g. for handling such as e.g. controlling a data transmission over a bearer in a wireless communications network 100, the UE 102 may comprise the arrangement depicted in FIG. 16.

The UE 102 may comprise an input and output interface 1600 configured to communicate with the access node 104. The input and output interface may comprise a wireless receiver not shown) and a wireless transmitter not shown).

The embodiments herein may be implemented through a respective processor or one or more processors, such as the processor 1610 of a processing circuitry in UE 102 depicted in FIG. 16, together with respective computer program code for performing the functions and actions of the embodiments herein. The program code mentioned above may also be provided as a computer program product, for instance in the form of a data carrier carrying computer program code for performing the embodiments herein when being loaded into the UE 102. One such carrier may be in the form of a CD ROM disc. It is however feasible with other data carriers such as a memory stick. The computer program code may furthermore be provided as pure program code on a server and downloaded to the UE 102.

The UE 102 may further comprise a memory 1620 comprising one or more memory units. The memory comprises instructions executable by the processor in UE 102.

The memory is arranged to be used to store e.g. feedback options, information, data, configurations, and applications to perform the methods herein when being executed in the UE 102.

In some embodiments, a respective computer program1630 comprises instructions, which when executed by the respective at least one processor, cause the at least one processor of the UE 102 to perform the actions above.

In some embodiments, a respective carrier 1640 comprises the respective computer program, wherein the carrier is one of an electronic signal, an optical signal, an electromagnetic signal, a magnetic signal, an electric signal, a radio signal, a microwave signal, or a computer-readable storage medium.

See descriptions of modules 1650-1690 below under Embodiments.

Those skilled in the art will also appreciate that the modules in the UE 102, described above may refer to a combination of analog and digital circuits, and/or one or more processors configured with software and/or firmware, e.g. stored in the UE 102, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

Further Extensions and Variations

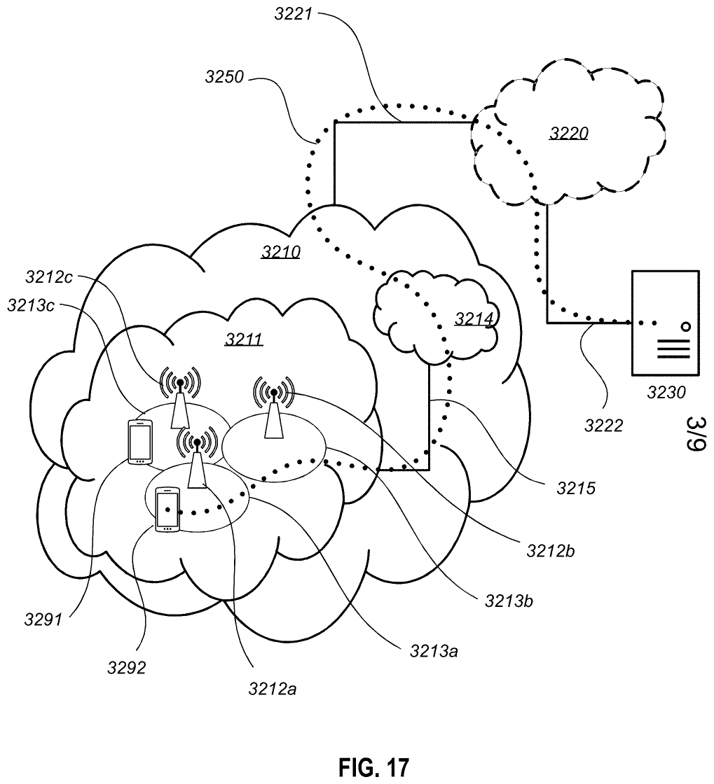

With reference to FIG. 17, in accordance with an embodiment, a communication system includes a telecommunication network 3210 e.g. a WLAN, such as a 3GPP-type cellular network, which comprises an access network 3211, such as a radio access network, and a core network 3214. The access network 3211 comprises a plurality of base stations 3212a, 3212b, 3212c, such as access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 17 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

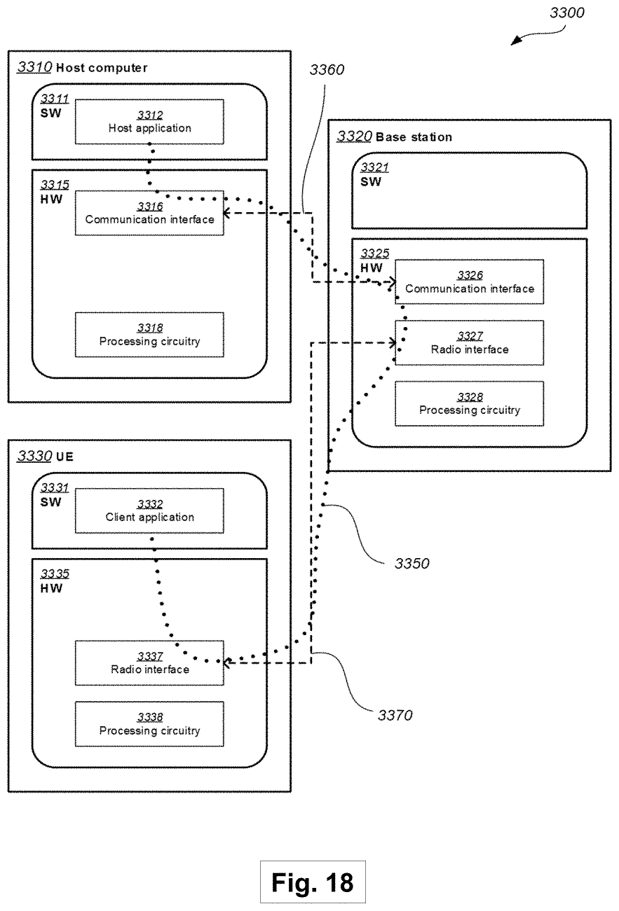

Example implementations, in accordance with an embodiment, of the UE, base station and host computer discussed in the preceding paragraphs will now be described with reference to FIG. 18. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 18) served by the base station 3320. The communication interface 3326 may be configured to facilitate a connection 3360 to the host computer 3310. The connection 3360 may be direct or it may pass through a core network (not shown in FIG. 18) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. It's hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 18 may be identical to the host computer 3230, one of the base stations 3212a, 3212b, 3212c and one of the UEs 3291, 3292 of FIG. 17, respectively. This is to say, the inner workings of these entities may be as shown in FIG. 18 and independently, the surrounding network topology may be that of FIG. 17.

In FIG. 18, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. [If the radio-related invention has not yet been formulated at the time of drafting a provisional application, the expression “embodiments described throughout this disclosure” is meant to refer to the radio-related embodiments disclosed elsewhere in the application.] One or more of the various embodiments improve the performance of OTT services provided to the UE 3330 using the OTT connection 3350, in which the wireless connection 3370 forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

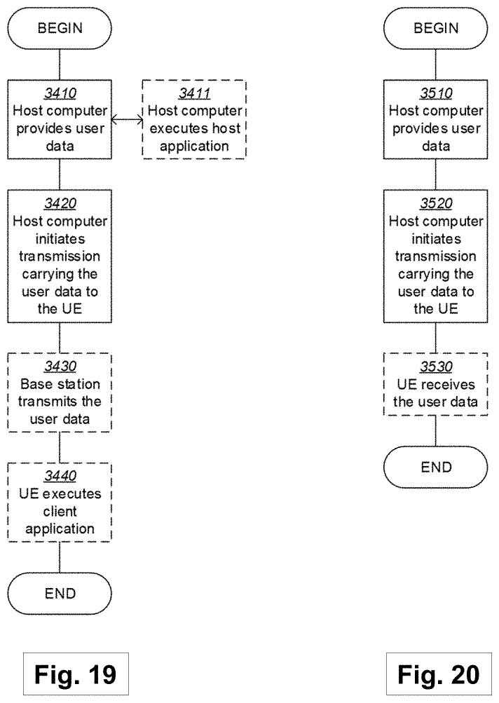

FIG. 19 is a flowchart illustrating a method implemented in a communication system, in accordance with one embodiment. The communication system includes a host computer, a base station such as an AP STA, and a UE such as a Non-AP STA which may be those described with reference to FIGS. 32 and 33. For simplicity of the present disclosure, only drawing references to FIG. 19 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 20 is a flowchart illustrating a method implemented in a communication system, in accordance with one embodiment. The communication system includes a host computer, a base station such as an AP STA, and a UE such as a Non-AP STA which may be those described with reference to FIGS. 32 and 33. For simplicity of the present disclosure, only drawing references to FIG. 20 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

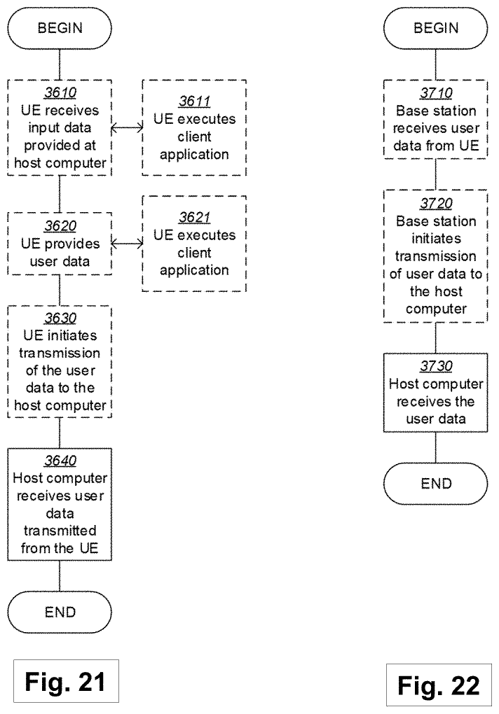

FIG. 21 is a flowchart illustrating a method implemented in a communication system, in accordance with one embodiment. The communication system includes a host computer, a base station such as an AP STA, and a UE such as a Non-AP STA which may be those described with reference to FIGS. 32 and 33. For simplicity of the present disclosure, only drawing references to FIG. 21 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station such as an AP STA, and a UE such as a Non-AP STA which may be those described with reference to FIGS. 32 and 33. For simplicity of the present disclosure, only drawing references to FIG. 22 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

Some example Embodiments numbered 1-16 are described below. The following embodiments refer among other things to FIG. 10, FIG. 11 and FIG. 16.

Embodiment 1. A method performed by a User Equipment, UE, 102 for handling such as e.g. controlling a data transmission over a bearer in a wireless communications network 100, the method comprising:

when the bearer is established, determining 1102, an access category for the data to be transmitted over the bearer,

associating 1104 the determined access category with the bearer, and

when the data is to be transmitted over the bearer, performing 1106 barring check of the access category associated with the bearer,

when the access category associated with the bearer is barred, deciding 1108 to not transmit the data, and

when the access category associated with the bearer is not barred, deciding 1110 to initiate a procedure to transmit the data over the bearer.

Embodiment 2. The method according to Embodiment 1, wherein the access category is decided based on any one or more out of:

QoS information, related to the bearer,

QoS flow ID of the bearer,

logical channel priority of the bearer, and

a service that triggered the establishment of the bearer.

Embodiment 3. The method according to any of the Embodiments 1-2, further comprising:

receiving 1105 barring information relating to different access categories from a node in the wireless communications network 100,

and wherein the barring check is performed by checking the barring information for the determined access category associated with the bearer among the different access categories and associated bearers.

Embodiment 4. The method according to any of the Embodiments 1-3, wherein the established bearer comprises any one out of: a created bearer, a reconfigured bearer, and resumed bearer.

Embodiment 5. The method according to any of the Embodiments 1-4, wherein the data to be transmitted over the bearer triggering the performing 1106 of the barring check relates to any of:

the UE 102 transitioning mode from Radio Resource Control, RRC, idle to RRC Connected,

the UE 102 transitioning mode from RRC inactive to RRC connected,

the UE 102 being in RRC connected mode.

Embodiment 6. The method according any of the Embodiments 1-5, wherein information about the determined access category and information about the associated bearer is stored as any one out of:

a UE context information on Access Stratum (AS) level in the UE 102, and

a UE context information on Non-Access Stratum (NAS) level in the UE 102.

Embodiment 7. The method according to any of the Embodiments 1-6 wherein the performing of the barring check is applicable to utilization of random access channels and selectively not applicable for utilization of other channels.

Embodiment 8. A computer program comprising instructions, which when executed by a processor, causes the processor to perform actions according to any of the Embodiments 1-7.

Embodiment 9. A carrier comprising the computer program of Embodiments 8, wherein the carrier is one of an electronic signal, an optical signal, an electromagnetic signal, a magnetic signal, an electric signal, a radio signal, a microwave signal, or a computer-readable storage medium.

Embodiment 10. A User Equipment, UE, 102 for handling such as e.g. controlling a data transmission over a bearer in a wireless communications network 100, the UE 102 being configure to:

when the bearer is established, determine, an access category for the data to be transmitted over the bearer, e.g. by means of a determining module 1650 in the UE 102

associate the determined access category with the bearer, e.g. by means of an associating module 1660 in the UE 102

when the data is to be transmitted over the bearer, perform barring check of the access category associated with the bearer, e.g. by means of a performing module 1670 in the UE 102, and

when the access category associated with the bearer is barred, decide to not transmit the data, e.g. by means of a deciding module 1680 in the UE 102, and

when the access category associated with the bearer is not barred, decide to initiate a procedure to transmit the data over the bearer e.g. by means of the deciding module in the UE 102.

Embodiment 11. The UE 102 according to Embodiment 10, wherein the access category is arranged to be decided based on any one or more out of:

QoS information, related to the bearer,

QoS flow ID of the bearer,

logical channel priority of the bearer, and

a service that triggered the establishment of the bearer.

Embodiment 12. The UE 102 according to any of the Embodiments 10-11, further being configured to:

receive barring information relating to different access categories from a node in the wireless communications network 100, e.g. by means of a receiving module 1690 in the UE 102,

and wherein the barring check is adapted to be performed by checking the barring information for the determined access category associated with the bearer among the different access categories and associated bearers.

Embodiment 13. The UE 102 according to any of the Embodiments 10-12, wherein the established bearer comprises any one out of: a created bearer, a reconfigured bearer, and resumed bearer.

Embodiment 14. The UE 102 according to any of the Embodiments 10-13, wherein the data to be transmitted over the bearer, triggering to perform the barring check is adapted to be related to any of:

the UE 102 transitioning mode from Radio Resource Control, RRC, idle to RRC Connected,

the UE 102 transitioning mode from RRC inactive to RRC connected,

the UE 102 being in RRC connected mode.

Embodiment 15. The UE 102 according to any of the Embodiments 10-14, wherein information about the determined access category and information about the associated bearer is adapted to be stored as any one out of:

UE context information on Access Stratum (AS) level in the UE 102, and.

UE context information on Non-Access Stratum (NAS) level in the UE 102.

Embodiment 16. The method according to any of the Embodiments 10-15 wherein the performed barring check is adapted to be applicable to utilization of random access channels and selectively not applicable for utilization of other channels.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### ABBREVIATION EXPLANATION

5GS 5G System

QFI QoS Flow Identifier

QCI QoS class identifier

501 5G QoS Indicator

AN Access Network

AN Access Node

SDF Service Data Flow

DRB Data Radio Bearer

EPS Evolved Packet System

AS Access Stratum

NAS Non-Access Stratum

1-14. (canceled)

15. A method performed by a User Equipment (UE) for controlling a data transmission over a bearer in a wireless communications network, the method comprising:
when the bearer is established, determining an access category for the data to be transmitted over the bearer;
associating the determined access category with the bearer;
when the data is to be transmitted over the bearer, performing a barring check of the access category associated with the bearer; and
deciding to not transmit the data or deciding to initiate a procedure to transmit the data over the bearer, depending respectively on whether the access category associated with the bearer is or is not barred according to the barring check.

16. The method according claim 15, wherein information about the determined access category and information about the associated bearer is stored as any one out of:
a UE context information on Access Stratum (AS) level in the UE, and
a UE context information on Non-Access Stratum (NAS) level in the UE.

17. The method according to claim 15, wherein the access category is decided based on any one or more out of:
quality of service (QoS) information related to the bearer,
QoS flow ID of the bearer,
logical channel priority of the bearer, and
a service that triggered the establishment of the bearer.

18. The method according to claim 15, further comprising:
receiving barring information relating to different access categories from a node in the wireless communications network, and
wherein the barring check is performed by checking the barring information for the determined access category associated with the bearer among the different access categories and associated bearers.

19. The method according to claim 15, wherein the established bearer comprises any one out of: a created bearer, a reconfigured bearer, and a resumed bearer.

20. The method according to claim 15, wherein the data to be transmitted over the bearer triggering the performing of the barring check relates to any of:
the UE transitioning mode from Radio Resource Control (RRC) idle to RRC Connected,
the UE transitioning mode from RRC inactive to RRC connected,
the UE being in RRC connected mode.

21. A User Equipment (UE) for controlling a data transmission over a bearer in a wireless communications network, the UE comprising:
processing circuitry configured to:
when the bearer is established, determine an access category for the data to be transmitted over the bearer;
associate the determined access category with the bearer;
when the data is to be transmitted over the bearer, perform a barring check of the access category associated with the bearer;
when the access category associated with the bearer is barred, decide to not transmit the data; and
when the access category associated with the bearer is not barred, decide to initiate a procedure to transmit the data over the bearer.

22. The UE according to claim 21, wherein the processing circuitry is configured to store in memory of the UE information about the determined access category and information about the associated bearer as any one out of:
UE context information on Access Stratum (AS) level in the UE, and
UE context information on Non-Access Stratum (NAS) level in the UE.

23. The UE according to claim 21, wherein the processing circuitry is configured to determine the access category based on any one or more out of:
quality of service (QoS) information related to the bearer,
QoS flow ID of the bearer,
logical channel priority of the bearer, and
a service that triggered the establishment of the bearer.

24. The UE according to claim 21, wherein the processing circuitry is configured to:
receive barring information relating to different access categories from a node in the wireless communications network; and
perform the barring check by checking the barring information for the determined access category associated with the bearer among the different access categories and associated bearers.

25. The UE according to claim 21, wherein the established bearer comprises any one out of: a created bearer, a reconfigured bearer, and a resumed bearer.

26. The UE according to claim 21, wherein the data to be transmitted over the bearer triggering the UE to perform the barring check relates to any of:
the UE transitioning mode from Radio Resource Control (RRC) idle to RRC Connected,
the UE transitioning mode from RRC inactive to RRC connected,
the UE being in RRC connected mode.

27. A non-transitory computer-readable storage medium having stored theron a instructions, which when executed by at least one processor of a user equipment UE), cause the UE to control a data transmission over a bearer in a wireless communications network, the instructions causing the UE to:
when the bearer is established, determine an access category for the data to be transmitted over the bearer;
associate the determined access category with the bearer;
when the data is to be transmitted over the bearer, perform a barring check of the access category associated with the bearer; and
decide to not transmit the data or decide to initiate a procedure to transmit the data over the bearer, depending respectively on whether the access category associated with the bearer is or is not barred according to the barring check.
